(19) United States
(12) Patent Application Publication
(10) Pub. No.: US 2016/0012449 A1
(43) Pub. Date: Jan. 14, 2016

(54) IDENTIFICATION OF CUSTOMERS ELIGIBLE FOR ADDITIONAL ASSISTANCE PROGRAMS BASED ON INDOOR POSITIONING SYSTEM DETECTION OF PHYSICAL CUSTOMER PRESENCE

(71) Applicant: Bank of America Corporation, Charlotte, NC (US)

(72) Inventor: Carrie Anne Hanson, Charlotte, NC (US)

(21) Appl. No.: 14/327,566

(22) Filed: Jul. 10, 2014

(51) Int. Cl. G06Q 30/00; H04W 4/04

(52) U.S. Cl. CPC G06Q 30/016; H04W 4/04

(57) ABSTRACT

A computing platform may receive a plurality of messages comprising data indicating physical presence of customers of a financial institution at a physical banking center location of the financial institution from an indoor positioning system located at the physical banking center location of the financial institution. Responsive to receiving the plurality of messages comprising the data indicating the physical presence of the customers of the financial institution at the physical banking center location of the financial institution, the computing platform may determine that at least one customer of the customers of the financial institution at the physical banking center location of the financial institution is eligible for an additional assistance program offered by the financial institution.

### BACKGROUND

Many organizations offer additional assistance programs to their customers. Often, however, eligible customers are not aware of these additional assistance programs or their eligibility for them. One of the most effective means of notifying customers of additional assistance programs for which they are eligible is in the in-person context, where customers are physically present at a location of the organization and interact with representatives of the organization. Because the customers may not be at the location in connection with the additional assistance programs, however, representatives present at the organization may be unaware that eligible customers are present, and may fail to recognize the opportunity to notify the customers of the existence of the additional assistance programs or the customers' eligibility for them. Accordingly, a need exists for identification of customers eligible for additional assistance programs based on indoor positioning system detection of physical customer presence.

### SUMMARY

The following presents a simplified summary in order to provide a basic understanding of some aspects of the disclosure. This summary is not an extensive overview of the disclosure. It is intended neither to identify key or critical elements of the disclosure nor to delineate the scope of the disclosure. The following summary merely presents some concepts of the disclosure in a simplified form as a prelude to the description below.

In accordance with one or more embodiments, a computing platform may receive a plurality of messages comprising data indicating physical presence of customers of a financial institution at a physical banking center location of the financial institution from an indoor positioning system located at the physical banking center location of the financial institution. Responsive to receiving the plurality of messages comprising the data indicating the physical presence of the customers of the financial institution at the physical banking center location of the financial institution, the computing platform may determine that at least one customer of the customers of the financial institution at the physical banking center location of the financial institution is eligible for an additional assistance program offered by the financial institution.

In some embodiments, the plurality of messages comprising data indicating the physical presence of the customers of the financial institution at the physical banking center location of the financial institution may include a plurality of customer identifiers. Each customer identifier of the plurality of customer identifiers may identify a customer of the customers of the financial institution at the physical banking center location of the financial institution.

In some embodiments, the computing platform may receive one or more messages comprising data indicating a plurality of customers of the financial institution that are eligible for one or more additional assistance programs offered by the financial institution from a customer management system of the financial institution. The computing platform may generate a plurality of records comprising the data indicating the plurality of customers of the financial institution that are eligible for the one or more additional assistance programs offered by the financial institution, and may store the plurality of records comprising the data indicating the plurality of customers of the financial institution that are eligible for the one or more additional assistance programs offered by the financial institution in a memory. In such embodiments, determining that the at least one customer of the customers of the financial institution at the physical banking center location of the financial institution is eligible for the additional assistance program offered by the financial institution may comprise identifying, from amongst the plurality of records comprising the data indicating the plurality of customers of the financial institution that are eligible for the one or more additional assistance programs offered by the financial institution, at least one record comprising data associated with a customer identifier of the plurality of customer identifiers.

In some embodiments, the indoor positioning system may include a plurality of personal computing devices presently in possession of the customers of the financial institution at the physical banking center location of the financial institution. The indoor positioning system may also include at least one location beacon that is located at the physical banking center location of the financial institution and configured to emit a signal comprising an identifier associated with the physical banking center location. In such embodiments, receiving the plurality of messages comprising data indicating the physical presence of the customers of the financial institution at the physical banking center location of the financial institution may include receiving data comprising the identifier associated with the physical banking center location from the plurality of personal computing devices.

In some embodiments, the indoor positioning system may include a location beacon that is located at a first location of the physical banking center location of the financial institution and configured to emit a signal comprising an identifier associated with the first location of the physical banking center location of the financial institution, and a location beacon that is located at a second location of the physical banking center location of the financial institution and configured to emit a signal comprising an identifier associated with the second location of the physical banking center location of the financial institution. In such embodiments, receiving the plurality of messages comprising data indicating physical presence of the customers of the financial institution at the physical banking center location of the financial institution may include receiving messages comprising data indicating physical presence of a portion of the customers of the financial institution at the first location of the physical banking center location of the financial institution, and receiving messages comprising data indicating physical presence of a portion of the customers of the financial institution at the second location of the physical banking center location of the financial institution.

In some embodiments, determining that at least one customer of the customers of the financial institution at the physical banking center location of the financial institution is eligible for the additional assistance program offered by the financial institution may include determining that a customer of the portion of the customers of the financial institution at the first location of the physical banking center location of the financial institution is eligible for the additional assistance program offered by the financial institution, and determining that a customer of the portion of the customers of the financial institution at the second location of the physical banking center location of the financial institution is eligible for the additional assistance program offered by the financial institution.

In some embodiments, the computing platform may receive messages comprising data indicating physical presence of associates of the financial institution at the first location of the physical banking center location of the financial institution from the indoor positioning system located at the physical banking center location of the financial institution. The computing platform may receive messages comprising data indicating physical presence of associates of the financial institution at the second location of the physical banking center location of the financial institution from the indoor positioning system located at the physical banking center location of the financial institution. In such embodiments, the computing platform may identify, from amongst the associates of the financial institution at the first location of the physical banking center location of the financial institution, an associate of the financial institution to assist the customer of the portion of the customers of the financial institution at the first location of the physical banking center location of the financial institution with the additional assistance program offered by the financial institution. The computing platform may identify, from amongst the associates of the financial institution at the second location of the physical banking center location of the financial institution, an associate of the financial institution to assist the customer of the portion of the customers of the financial institution at the second location of the physical banking center location of the financial institution with the additional assistance program offered by the financial institution.

In some embodiments, the computing platform may generate a message indicating that the customer of the portion of the customers of the financial institution at the first location of the physical banking center location of the financial institution is eligible for the additional assistance program offered by the financial institution. The computing platform may generate a message indicating that the customer of the portion of the customers of the financial institution at the second location of the physical banking center location of the financial institution is eligible for the additional assistance program offered by the financial institution.

In some embodiments, the computing platform may identify a personal computing device presently in possession of the customer of the portion of the customers of the financial institution at the first location of the physical banking center location of the financial institution based on the messages comprising data indicating physical presence of the portion of the customers of the financial institution at the first location of the physical banking center location of the financial institution. The computing platform may identify a personal computing device presently in possession of the customer of the portion of the customers of the financial institution at the second location of the physical banking center location of the financial institution based on the messages comprising data indicating physical presence of the portion of the customers of the financial institution at the second location of the physical banking center location of the financial institution. The computing platform may communicate the message indicating that the customer of the portion of the customers of the financial institution at the first location of the physical banking center location of the financial institution is eligible for the additional assistance program offered by the financial institution to the personal computing device presently in possession of the customer of the portion of the customers of the financial institution at the first location of the physical banking center location of the financial institution. The computing platform may communicate the message indicating that the customer of the portion of the customers of the financial institution at the second location of the physical banking center location of the financial institution is eligible for the additional assistance program offered by the financial institution to the personal computing device presently in possession of the customer of the portion of the customers of the financial institution at the second location of the physical banking center location of the financial institution.

In some embodiments, the computing platform may identify a personal computing device presently in possession of the associate of the financial institution to assist the customer of the portion of the customers of the financial institution at the first location of the physical banking center location of the financial institution with the additional assistance program offered by the financial institution based on the messages comprising data indicating physical presence of associates of the financial institution at the first location of the physical banking center location of the financial institution. The computing platform may identify a personal computing device presently in possession of the associate of the financial institution to assist the customer of the portion of the customers of the financial institution at the second location of the physical banking center location of the financial institution with the additional assistance program offered by the financial institution based on the messages comprising data indicating physical presence of associates of the financial institution at the second location of the physical banking center location of the financial institution. The computing platform may communicate the message indicating that the customer of the portion of the customers of the financial institution at the first location of the physical banking center location of the financial institution is eligible for the additional assistance program offered by the financial institution to the personal computing device presently in possession of the associate of the financial institution to assist the customer of the portion of the customers of the financial institution at the first location of the physical banking center location of the financial institution with the additional assistance program offered by the financial institution. The computing platform may communicate the message indicating that the customer of the portion of the customers of the financial institution at the second location of the physical banking center location of the financial institution is eligible for the additional assistance program offered by the financial institution to the personal computing device presently in possession of the associate of the financial institution to assist the customer of the portion of the customers of the financial institution at the second location of the physical banking center location of the financial institution with the additional assistance program offered by the financial institution.

In some embodiments, responsive to determining that the at least one customer of the customers of the financial institution at the physical banking center location of the financial institution is eligible for the additional assistance program offered by the financial institution, the computing platform may generate a message identifying the at least one customer of the customers of the financial institution at the physical banking center location of the financial institution, identifying the additional assistance program offered by the financial institution, and indicating that the at least one customer of the customers of the financial institution at the physical banking center location of the financial institution is eligible for the additional assistance program offered by the financial institution, and may communicate the message identifying the at least one customer of the customers of the financial institution at the physical banking center location of the financial institution, identifying the additional assistance program offered by the financial institution, and indicating that the at least one customer of the customers of the financial institution at the physical banking center location of the financial institution is eligible for the additional assistance program offered by the financial institution to at least one computing device located at the physical banking center location of the financial institution.

In some embodiments, the computing platform may identify the at least one computing device located at the physical banking center location of the financial institution based on the plurality of messages comprising data indicating physical presence of customers of the financial institution at the physical banking center location of the financial institution. In such embodiments, the at least one computing device located at the physical banking center location of the financial institution may include a personal computing device presently in possession of the at least one customer of the customers of the financial institution at the physical banking center location of the financial institution.

In some embodiments, the computing platform may receive a plurality of messages comprising data indicating physical presence of associates of the financial institution at the physical banking center location of the financial institution from the indoor positioning system located at the physical banking center location of the financial institution. In such embodiments, the computing platform may identify the at least one computing device located at the physical banking center location of the financial institution based on the plurality of messages comprising data indicating physical presence of associates of the financial institution at the physical banking center location of the financial institution, and the at least one computing device located at the physical banking center location of the financial institution may include a personal computing device presently in possession of an associate of the associates of the financial institution at the physical banking center location of the financial institution.

In some embodiments, determining that the at least one customer of the customers of the financial institution at the physical banking center location of the financial institution is eligible for the additional assistance program offered by the financial institution may include determining that the at least one customer of the customers of the financial institution at the physical banking center location of the financial institution is eligible for an additional assistance program offered by the financial institution that comprises a workout program for addressing one or more loans for which the at least one customer of the customers of the financial institution at the physical banking center location of the financial institution is currently eligible, an additional assistance program offered by the financial institution that comprises verifying one or more charges incurred by the at least one customer of the customers of the financial institution at the physical banking center location of the financial institution, and/or an additional assistance program offered by the financial institution that comprises an incentive program for maintaining an account the at least one customer of the customers of the financial institution at the physical banking center location of the financial institution has with the financial institution that has a transaction history indicative of imminent closure.

Other details and features will be described in the sections that follow.

### BRIEF DESCRIPTION OF THE DRAWINGS

The present disclosure is pointed out with particularity in the appended claims. Features of the disclosure will become more apparent upon a review of this disclosure in its entirety, including the drawing figures provided herewith.

Some features herein are illustrated by way of example, and not by way of limitation, in the figures of the accompanying drawings, in which like reference numerals refer to similar elements, and wherein:

FIG. 1 depicts an illustrative operating environment in which various aspects of the present disclosure may be implemented in accordance with one or more example embodiments;

FIG. 2 depicts an illustrative block diagram of workstations and servers that may be used to implement the processes and functions of certain aspects of the present disclosure in accordance with one or more example embodiments;

FIG. 3 depicts an illustrative computing environment for identification of customers eligible for additional assistance programs based on indoor positioning system detection of physical customer presence in accordance with one or more example embodiments;

FIGS. 4A and 4B depict an illustrative event sequence for identification of customers eligible for additional assistance programs based on indoor positioning system detection of physical customer presence in accordance with one or more example embodiments;

FIG. 5 depicts an example customer message for identification of customers eligible for additional assistance programs based on indoor positioning system detection of physical customer presence in accordance with one or more example embodiments;

FIG. 6 depicts an example associate message for identification of customers eligible for additional assistance programs based on indoor positioning system detection of physical customer presence in accordance with one or more example embodiments; and

FIG. 7 depicts an illustrative method for identification of customers eligible for additional assistance programs based on indoor positioning system detection of physical customer presence in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

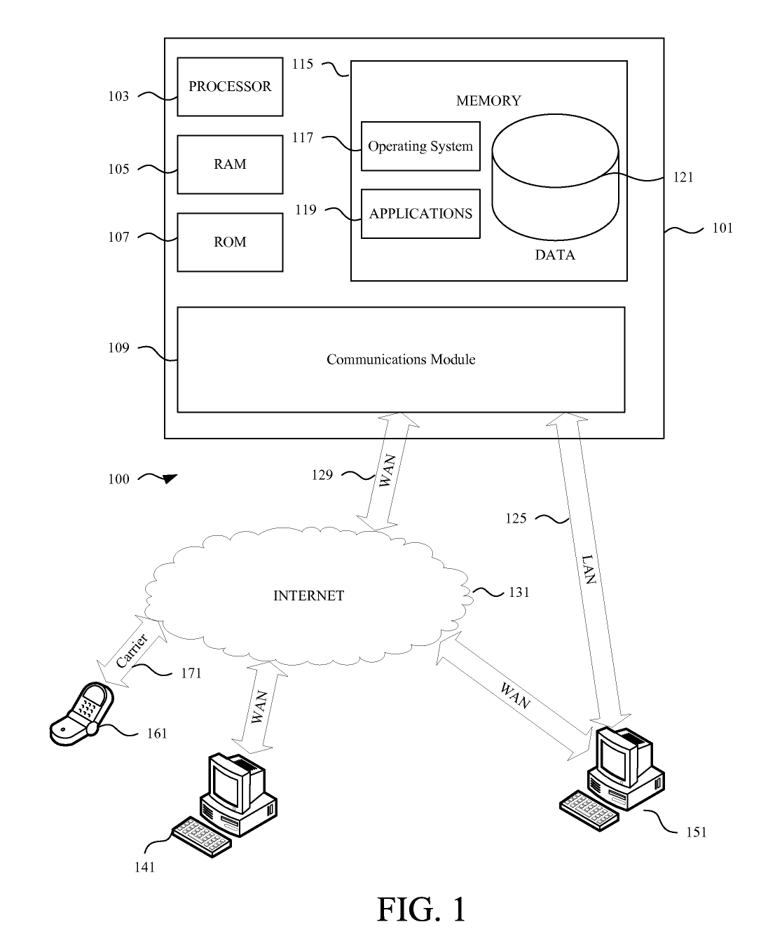

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141, 151, and 161. Computing devices 141, 151, and 161 may be personal computing devices or servers that include any or all of the elements described above relative to computing device 101. Computing device 161 may be a mobile device (e.g., smart phone) communicating over wireless carrier channel 171.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

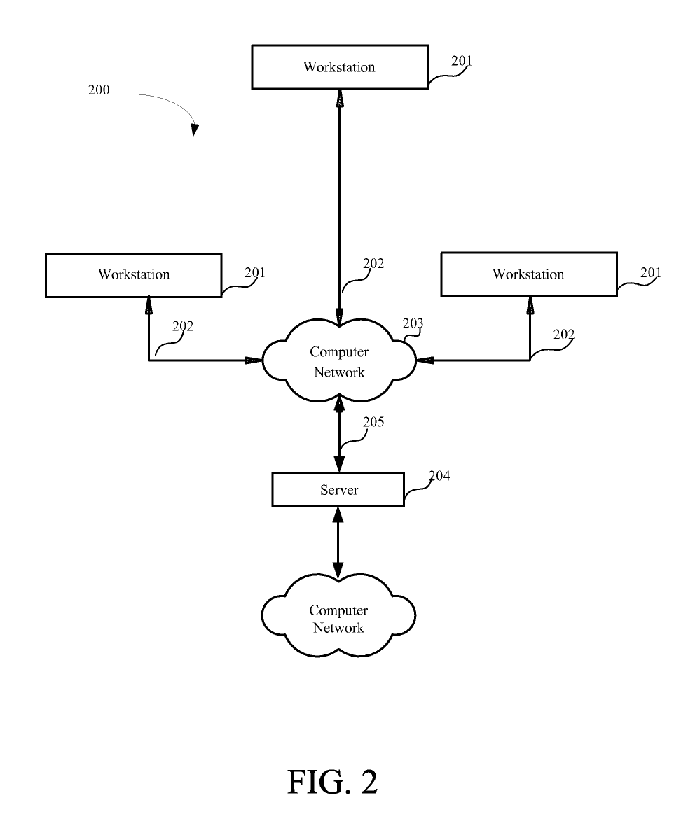

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, as well as network types developed in the future, and the like.

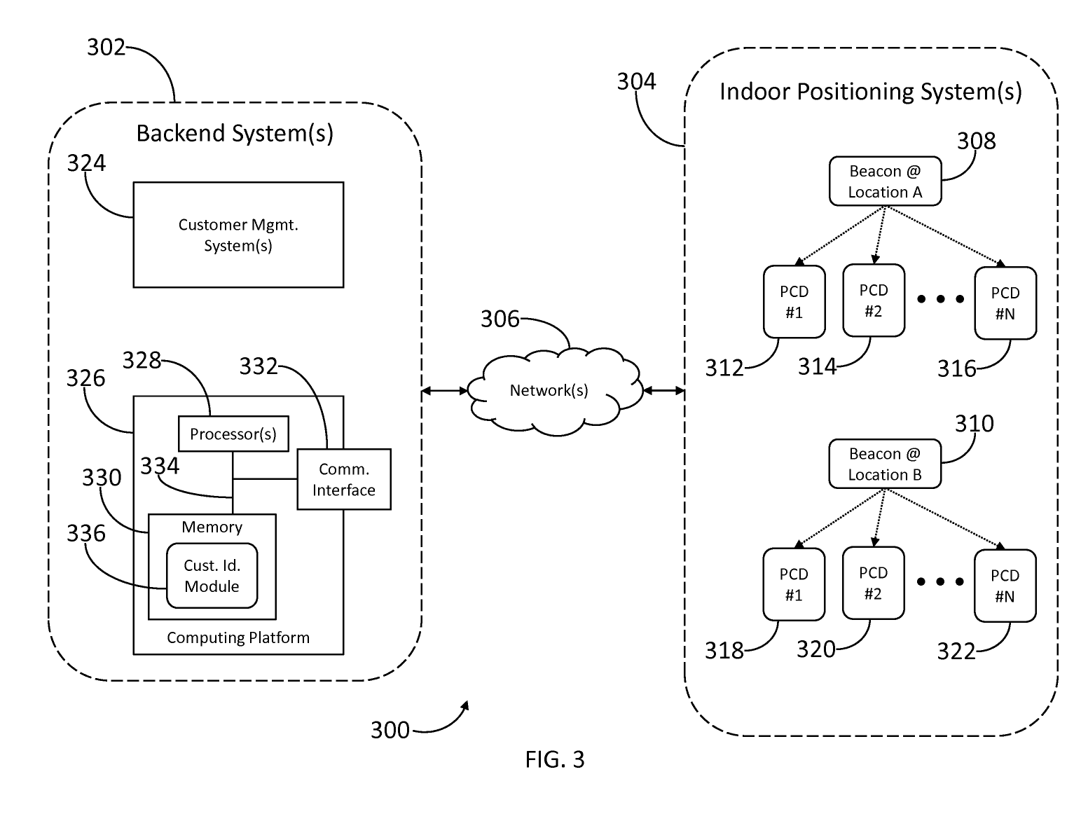

FIG. 3 depicts an illustrative computing environment for identification of customers eligible for additional assistance programs based on indoor positioning system detection of physical customer presence in accordance with one or more example embodiments. Referring to FIG. 3, computing environment 300 may include one or more computing systems. For example, computing environment 300 may include backend computing system(s) 302 and indoor positioning system(s) 304. As will be described in greater detail below, backend computing system(s) 302 and/or indoor positioning system(s) 304 may include one or more computing devices associated with an organization (e.g., a financial institution). Indoor positioning system(s) 304 may be located at a particular physical location associated with the organization (e.g., a physical banking center location of the financial institution). In some embodiments, backend computing system(s) 302 may be located at a different geographic location from indoor positioning system(s) 304 (e.g., a central processing facility associated with the financial institution). Computing environment 300 may also include one or more networks. For example, computing environment 300 may include network(s) 306. Network(s) 306 may interconnect one or more computing devices of backend computing system(s) 302, and/or one or more computing devices of indoor positioning system(s) 304, and may include one or more sub-networks (e.g., LANs, WANs, or the like).

Indoor positioning system(s) 304 may include one or more location beacons configured to emit or broadcast a signal (e.g., a Bluetooth Low Energy signal, a Bluetooth Smart signal, a low-power radio signal, or the like) comprising an identifier associated with its physical location (e.g., a physical banking center location of the financial institution and/or a location within the physical banking center location of the financial institution). For example, indoor positioning system(s) 304 may include location beacon 308 and location beacon 310. Location beacon 308 may be configured to emit a signal comprising an identifier associated with its physical location (e.g., Location “A”), for example, an identifier associated with the physical banking center location of the financial institution and/or a location within the physical banking center location of the financial institution (e.g., an area associated with one or more human tellers, an area associated with one or more automated teller machines, an area associated with one or more loan officers, an area associated with one or more financial planners, an area associated with one or more customer service professionals, an area associated with an indoor lobby, an area associated with an outdoor lobby, an area associated with a walk-up or drive-up window, or the like). Similarly, location beacon 310 may be configured to emit a signal comprising an identifier associated with its physical location (e.g., Location “B”), for example, an identifier associated with the physical banking center location of the financial institution and/or a different location within the physical banking center location of the financial institution. Indoor positioning system(s) 304 may also include one or more personal computing devices, which may be presently in the possession of individuals (e.g., customers and/or associates of the financial institution) located at indoor positioning system(s) 304's physical location. For example, indoor positioning system(s) 304 may include personal computing devices 312 and 314 through 316, and personal computing devices 318 and 320 through 322.

Personal computing devices 312 and 314 through 316, and/or personal computing devices 318 and 320 through 322 may be any type of computing device capable of detecting the signal(s) emitted or broadcast by location beacon 308 and/or location beacon 310, generating a messaging indicating detection of the signal(s), and communicating the message indicating detection of the signal(s) to one or more other computing devices. For example, personal computing devices 312 and 314 through 316, and/or personal computing devices 318 and 320 through 322 may include one or more laptop computers, tablet computers, smart phones, mobile devices, near field communication tags, or the like. As will be described in greater detail below, when located within a proximity (e.g., zero to one hundred meters) of location beacon 308 and/or location beacon 310, personal computing devices 312 and 314 through 316, and/or personal computing devices 318 and 320 through 322 may be configured to detect signal(s) emitted by location beacon 308 and/or location beacon 310. Responsive to detecting signal(s) emitted by location beacon 308 and/or location beacon 310, personal computing devices 312 and 314 through 316, and/or personal computing devices 318 and 320 through 322 may be configured to generate a message indicating detection of the signal(s), and communicate the message to one or more other computing devices (e.g., one or more computing devices of backend computing system(s) 302). As indicated above, the signal(s) emitted by location beacon 308 and/or location beacon 310 may comprise one or more identifiers associated with their respective locations (e.g., Location “A,” Location “B,” or the like), and the message(s) generated by personal computing devices 312 and 314 through 316, and/or personal computing devices 318 and 320 through 322 responsive to detection of the signal(s) may comprise the identifier(s) and/or information identified utilizing the identifier(s) (e.g., information associated with Location “A,” Location “B,” or the like). Additionally or alternatively, the message(s) generated by personal computing devices 312 and 314 through 316, and/or personal computing devices 318 and 320 through 322 responsive to detection of the signal(s) may comprise identifiers associated with an individual presently in possession of one or more of personal computing devices 312 and 314 through 316, and/or personal computing devices 318 and 320 through 322, for example, customer identifier(s), associate identifier(s), or the like.

Backend computing system(s) 302 may include one or more computing devices associated with the organization (e.g., the financial institution). For example, backend computing system(s) 302 may include customer management system(s) 324 and computing platform 326. As will be described in greater detail below, customer management system(s) 324 may include one or more computing devices (e.g., mainframes, servers, server blades, or the like) configured to maintain information regarding customers of the organization (e.g., whether one or more customers of the organization are eligible for one or more additional assistance programs offered by the organization). Computing platform 326 may include one or more processor(s) 328, memory 330, communication interface 332, and data bus 334. Data bus 334 may interconnect processor(s) 328, memory 330, and/or communication interface 332. Communication interface 332 may be a network interface configured to support communications between computing platform 326 and network(s) 306, or one or more sub-networks thereof. Memory 330 may include one or more program modules comprising instructions that when executed by processor(s) 328 cause computing platform 326 to perform one or more functions described herein. For example, memory 330 may include customer identification module 336, which may comprise instructions that when executed by processor(s) 328 may cause computing platform 326 to perform one or more functions described herein.

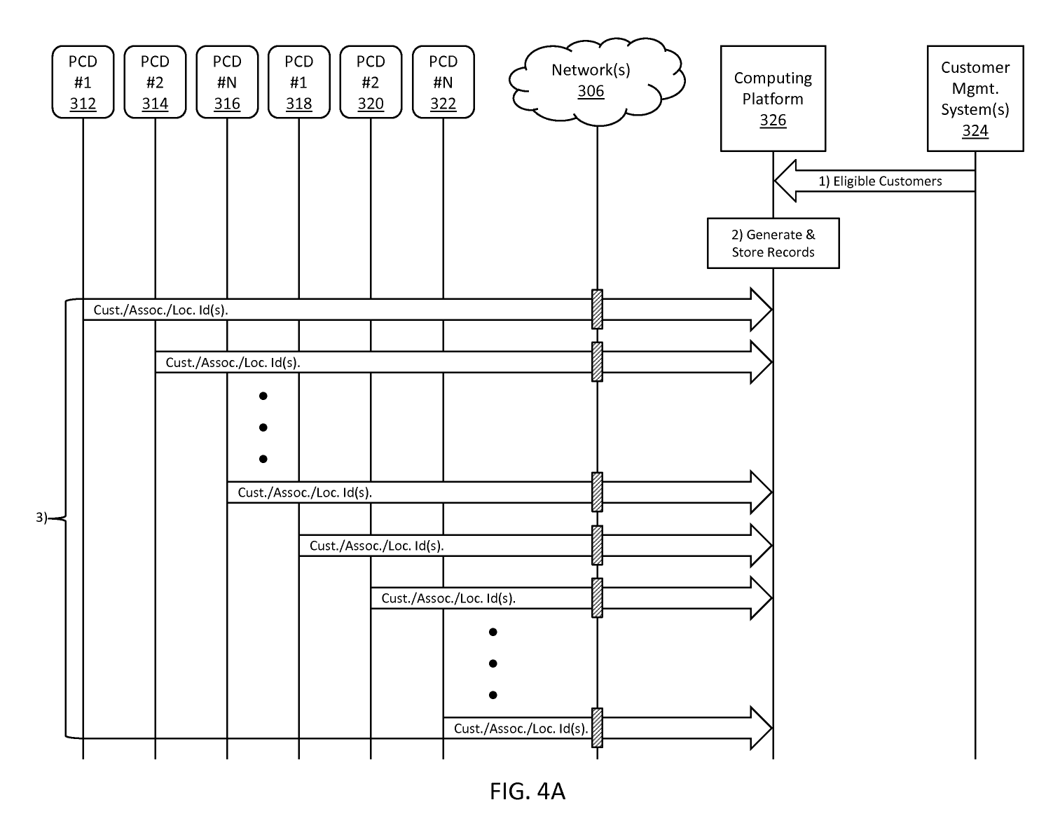

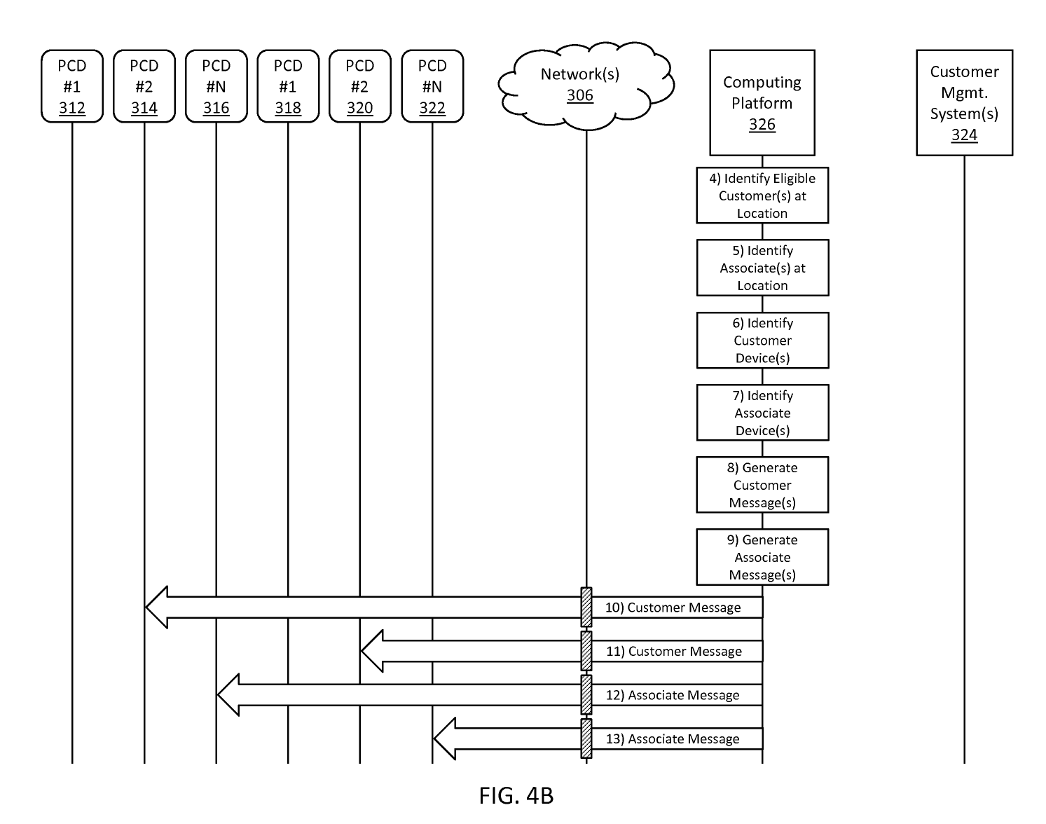

FIGS. 4A and 4B depict an illustrative event sequence for identification of customers eligible for additional assistance programs based on indoor positioning system detection of physical customer presence in accordance with one or more example embodiments. Referring to FIG. 4A, at step 1, one or more computing devices of customer management system(s) 324 may communicate one or more messages comprising data indicating a plurality of customers of the organization that are eligible for one or more additional assistance programs offered by the organization. For example, the organization may be a financial institution, and the additional assistance program(s) may include a workout program for addressing one or more loans for which a customer of the financial institution is currently eligible, an additional assistance program offered by the financial institution that comprises verifying one or more charges incurred by a customer of the financial institution, and/or an incentive program for maintaining an account a customer of the financial institution has with the financial institution that has a transaction history indicative of imminent closure (e.g., a series of recent withdrawals). Computing platform 326 may receive (e.g., via communication interface 332) the message(s) comprising the data indicating the plurality of customers of the organization that are eligible for the one or more additional assistance programs offered by the organization, and, at step 2, may generate a plurality of records comprising the data indicating the plurality of customers of the organization that are eligible for the one or more additional assistance programs offered by the organization, and may store the plurality of records comprising the data indicating the plurality of customers of the organization that are eligible for the one or more additional assistance programs offered by the organization (e.g., in memory 330).

At step 3, computing platform 326 may receive (e.g., via communication interface 332 and network(s) 306) a plurality of messages comprising data indicating physical presence of individuals associated with an organization (e.g., customers and/or associates of a financial institution) at a physical location of the organization from indoor positioning system(s) 304 (e.g., an indoor positioning system located at a physical banking center location of the financial institution). For example, individuals (e.g., customers and/or associates of the financial institution) presently in possession of personal computing devices 312 and 314 through 316 may be located within a predetermined proximity of location beacon 308 (e.g., at Location “A”), and personal computing devices 312 and 314 through 316 may detect a signal emitted by location beacon 308 comprising an identifier associated with its location, and, responsive to detecting the signal, may generate and communicate to computing platform 326 (e.g., via network(s) 306) one or more messages indicating their physical presence within the proximity of location beacon 308. Similarly, individuals (e.g., customers and/or associates of the financial institution) presently in possession of personal computing devices 318 and 320 through 322 may be located within a predetermined proximity of location beacon 310 (e.g., at Location “B”), and personal computing devices 318 and 320 through 322 may detect a signal emitted by location beacon 310 comprising an identifier associated with its location, and, responsive to detecting the signal, may generate and communicate to computing platform 326 (e.g., via network(s) 306) one or more messages indicating their physical presence within the proximity of location beacon 310.

In some embodiments, each of the plurality of messages may include an identifier associated with the location (e.g., the identifier contained in the signal emitted by location beacon 308 and/or location beacon 310, information identified utilizing the identifier(s), or the like) and/or one or more identifiers associated with an individual (e.g., an associate or customer of the financial institution) presently in possession of the personal computing device that generated the message. For example, a message received from personal computing device 312 may comprise an identifier associated with Location “A” and/or an identifier associated with an individual presently in possession of personal computing device 312 (e.g., at Location “A”). Similarly, a message received from personal computing device 314 may comprise an identifier associated with Location “A” and/or an identifier associated with an individual presently in possession of personal computing device 314 (e.g., at Location “A”); a message received from personal computing device 316 may comprise an identifier associated with Location “A” and/or an identifier associated with an individual presently in possession of personal computing device 316 (e.g., at Location “A”); a message received from personal computing device 318 may comprise an identifier associated with Location “B” and/or an identifier associated with an individual presently in possession of personal computing device 318 (e.g., at Location “B”); a message received from personal computing device 320 may comprise an identifier associated with Location “B” and/or an identifier associated with an individual presently in possession of personal computing device 320 (e.g., at Location “B”); and a message received from personal computing device 322 may comprise an identifier associated with Location “B” and/or an identifier associated with an individual presently in possession of personal computing device 322 (e.g., at Location “B”).

Referring to FIG. 4B, responsive to receiving the plurality of messages comprising the data indicating the physical presence of the customers of the organization at the physical location(s) of the organization associated with indoor positioning system(s) 304 (e.g., Location “A” and/or Location “B”), at step 4, computing platform 326 may identify at least one customer of the customers of the organization at the physical location(s) of the organization associated with indoor positioning system(s) 304 that is eligible for an additional assistance program offered by the organization. For example, as indicated above, the message received from personal computing device 312 may comprise a customer identifier associated with an individual (e.g., a customer) presently in possession of personal computing device 312 (e.g., at Location “A”). Similarly, the message received from personal computing device 314 may comprise a customer identifier associated with an individual (e.g., a customer) presently in possession of personal computing device 314 (e.g., at Location “A”); the message received from personal computing device 318 may comprise a customer identifier associated with an individual (e.g., a customer) presently in possession of personal computing device 318 (e.g., at Location “B”), and the message received from personal computing device 320 may comprise a customer identifier associated with an individual (e.g., a customer) presently in possession of personal computing device 320 (e.g., at Location “B”).

In some embodiments, computing platform 326 may determine that at least one customer of the customers of the organization at the physical location(s) of the organization associated with indoor positioning system(s) 304 is eligible for an additional assistance program offered by the organization by identifying, from amongst the plurality of records comprising the data indicating the plurality of customers of the organization that are eligible for the one or more additional assistance programs offered by the organization (e.g., the records generated and stored in step 2 above), at least one record comprising data associated with a customer identifier of the plurality of customer identifiers. For example, computing platform 326 may determine that the individual (e.g., the customer) presently in possession of personal computing device 314 (e.g., at Location “A”) is eligible for an additional assistance program offered by the organization by identifying, from amongst the plurality of records comprising the data indicating the plurality of customers of the organization that are eligible for the one or more additional assistance programs offered by the organization (e.g., the records generated and stored in step 2 above), at least one record comprising data associated with the customer identifier in the message received from personal computing device 314 (e.g., in step 3 above). Similarly, computing platform 326 may determine that the individual (e.g., the customer) presently in possession of personal computing device 320 (e.g., at Location “B”) is eligible for an additional assistance program offered by the organization by identifying, from amongst the plurality of records comprising the data indicating the plurality of customers of the organization that are eligible for the one or more additional assistance programs offered by the organization (e.g., the records generated and stored in step 2 above), at least one record comprising data associated with the customer identifier in the message received from personal computing device 320 (e.g., in step 3 above).

At step 5, computing platform 326 may identify one or more associates located at the physical location(s) of the organization associated with indoor positioning system(s) 304 where the customer(s) of the organization identified as eligible for the one or more additional assistance programs offered by the organization are located to assist the customer(s) at the physical location(s) with the additional assistance program(s) offered by the organization. For example, as indicated above, the message received from personal computing device 316 may comprise an associate identifier associated with an individual (e.g., an associate) presently in possession of personal computing device 316 (e.g., at Location “A”), and computing platform 326 may identify the individual (e.g., the associate) presently in possession of personal computing device 316 (e.g., at Location “A”) to assist the individual (e.g., the customer) presently in possession of personal computing device 314 (e.g., at Location “A”) that is eligible for the additional assistance program offered by the organization with the additional assistance program offered by the organization. Similarly, the message received from personal computing device 322 may comprise an associate identifier associated with an individual (e.g., an associate) presently in possession of personal computing device 322 (e.g., at Location “B”), and computing platform 326 may identify the individual (e.g., the associate) presently in possession of personal computing device 322 (e.g., at Location “B”) to assist the individual (e.g., the customer) presently in possession of personal computing device 320 (e.g., at Location “B”) that is eligible for the additional assistance program offered by the organization with the additional assistance program offered by the organization.

At step 6, computing platform 326 may identify one or more personal computing devices presently in possession of the customer(s), located at the physical location(s) of the organization associated with indoor positioning system(s) 304, identified as eligible for the additional assistance program(s) offered by the organization. For example, computing platform 326 may identify personal computing device 314 based on the message received from personal computing device 314 (e.g., in step 3 above). Similarly, computing platform 326 may identify personal computing device 320 based on the message received from personal computing device 320 (e.g., in step 3 above). At step 7, computing platform 326 may identify one or more personal computing devices presently in possession of the associate(s), located at the physical location(s) of the organization associated with indoor positioning system(s) 304, identified to assist the customer(s) eligible for the additional assistance program(s) offered by the organization with the additional assistance program(s) offered by the organization. For example, computing platform 326 may identify personal computing device 316 based on the message received from personal computing device 316 (e.g., in step 3 above). Similarly, computing platform 326 may identify personal computing device 322 based on the message received from personal computing device 322 (e.g., in step 3 above).

At step 8, computing platform 326 may generate one or more customer messages indicating that the customer(s) located at the physical location(s) of the organization associated with indoor positioning system(s) 304 are eligible for the additional assistance program(s) offered by the organization. For example, computing platform 326 may generate a customer message indicating that the customer presently in possession of personal computing device 314 (e.g., at Location “A”) is eligible for an additional assistance program offered by the organization. Similarly, computing platform 326 may generate a customer message indicating that the customer presently in possession of personal computing device 320 (e.g., at Location “B”) is eligible for an additional assistance program offered by the organization.

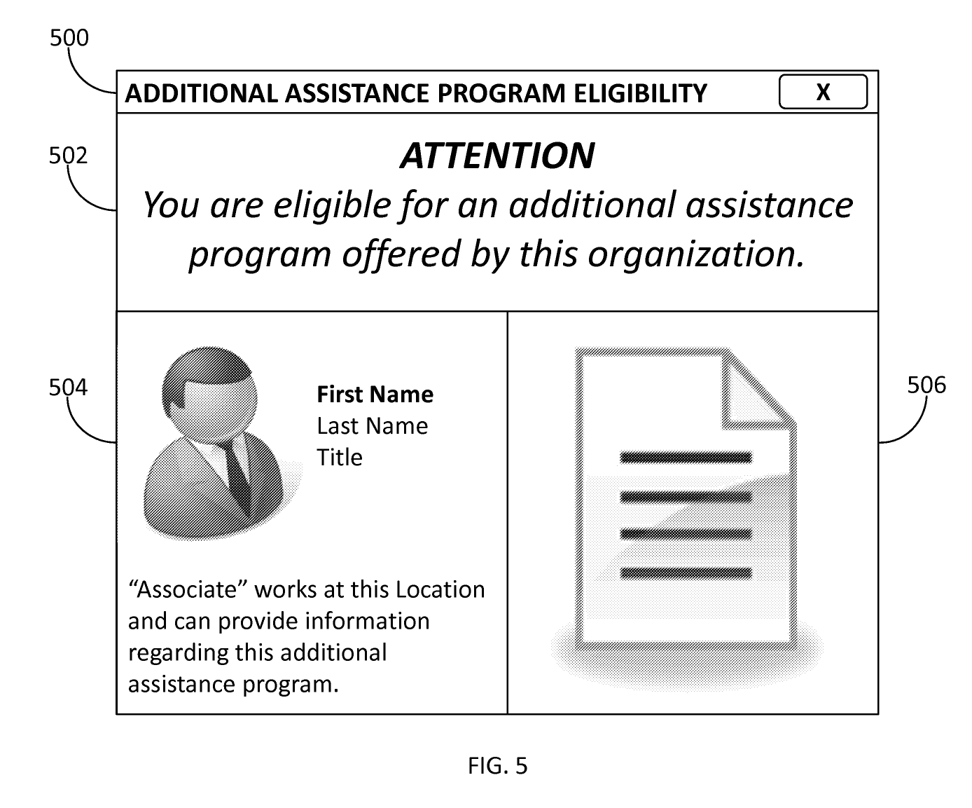

FIG. 5 depicts an example customer message for identification of customers eligible for additional assistance programs based on indoor positioning system detection of physical customer presence in accordance with one or more example embodiments. Referring to FIG. 5, message 500 may include indication 502, indicating that the customer (e.g., the customer presently in possession of personal computing device 314 or the customer presently in possession of personal computing device 320) is eligible for the additional assistance program offered by the organization. Message 500 may also include section 504, which may identify an associate of the organization currently located at the physical location (e.g., the associate presently in possession of personal computing device 316 or the associate presently in possession of personal computing device 322) that has been identified to assist the customer with the additional assistance program offered by the organization for which the customer is eligible. Message 500 may also include section 506, which may include information regarding the additional assistance program for which the customer is eligible.

Returning to FIG. 4B, at step 9, computing platform 326 may generate one or more associate messages indicating that the customer(s) located at the physical location(s) of the organization associated with indoor positioning system(s) 304 are eligible for the additional assistance program(s) offered by the organization. For example, computing platform 326 may generate an associate message indicating that the customer presently in possession of personal computing device 314 (e.g., at Location “A”) is eligible for an additional assistance program offered by the organization. Similarly, computing platform 326 may generate an associate message indicating that the customer presently in possession of personal computing device 320 (e.g., at Location “B”) is eligible for an additional assistance program offered by the organization.

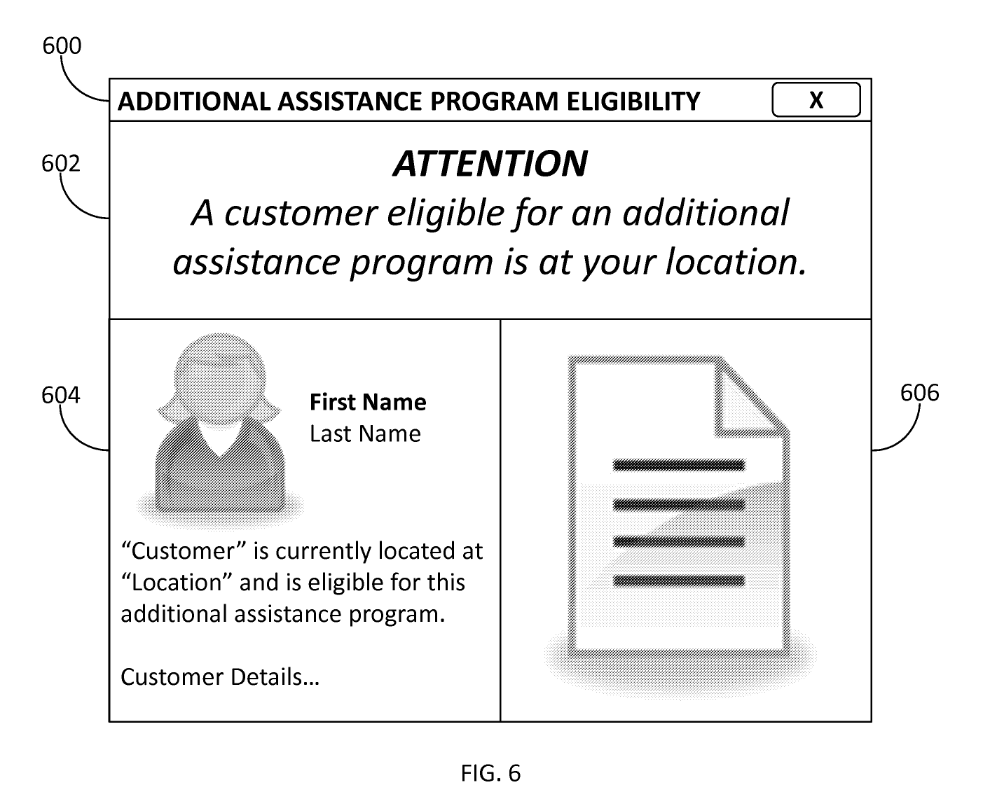

FIG. 6 depicts an example associate message for identification of customers eligible for additional assistance programs based on indoor positioning system detection of physical customer presence in accordance with one or more example embodiments. Referring to FIG. 6, message 600 may include indication 602, indicating that the customer (e.g., the customer presently in possession of personal computing device 314 and/or the customer presently in possession of personal computing device 320) is eligible for the additional assistance program offered by the organization. Message 600 may also include section 604, which may identify the customer of the organization currently located at the physical location (e.g., the customer presently in possession of personal computing device 314 and/or the customer presently in possession of personal computing device 320) that has been identified as eligible for the additional assistance program offered by the organization, and/or the location of the customer that has been identified as eligible for the additional assistance program offered by the organization within the location(s) associated with indoor positioning system(s) 304 (e.g., Location “A” or Location “B”). Message 600 may also include section 606, which may include information regarding the additional assistance program for which the customer is eligible.

Returning to FIG. 4B, at step 10, computing platform 326 may communicate (e.g., via communication interface 332 and network(s) 306) the customer message indicating that the customer presently in possession of personal computing device 314 is eligible for the additional assistance program offered by the organization to personal computing device 314 (e.g., to the customer presently in possession of personal computing device 314 at Location “A”). At step 11, computing platform 326 may communicate (e.g., via communication interface 332 and network(s) 306) the customer message indicating that the customer presently in possession of personal computing device 320 is eligible for the additional assistance program offered by the organization to personal computing device 320 (e.g., to the customer presently in possession of personal computing device 320 at Location “B”). At step 12, computing platform 326 may communicate (e.g., via communication interface 332 and network(s) 306) the associate message indicating that the customer presently in possession of personal computing device 314 is eligible for the additional assistance program offered by the organization to personal computing device 316 (e.g., to the associate at Location “A” identified to assist the customer presently in possession of personal computing device 314 with the additional assistance program offered by the organization for which the customer presently in possession of personal computing device 314 is eligible). At step 13, computing platform 326 may communicate (e.g., via communication interface 332 and network(s) 306) the associate message indicating that the customer presently in possession of personal computing device 320 is eligible for the additional assistance program offered by the organization to personal computing device 322 (e.g., to the associate at Location “B” identified to assist the customer presently in possession of personal computing device 320 with the additional assistance program offered by the organization for which the customer presently in possession of personal computing device 320 is eligible).

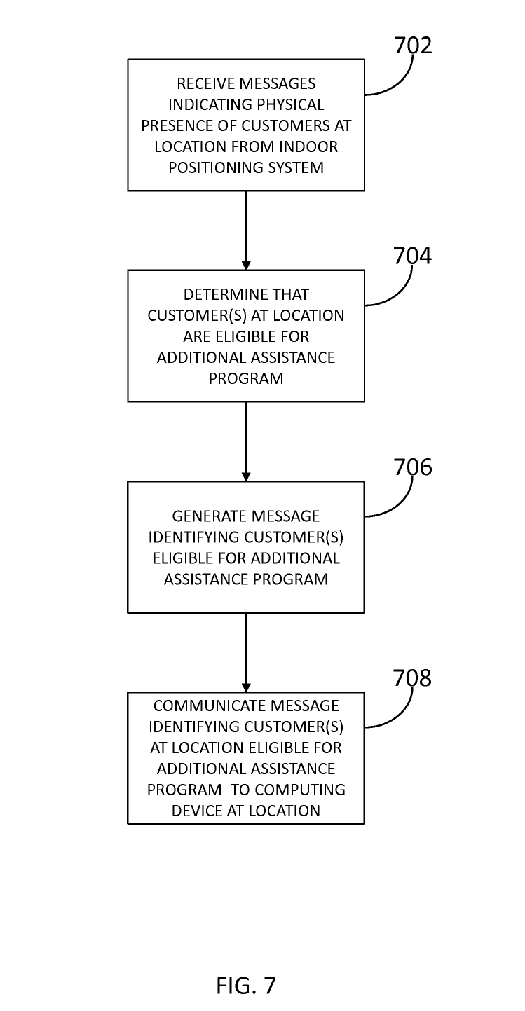

FIG. 7 depicts an illustrative method for identification of customers eligible for additional assistance programs based on indoor positioning system detection of physical customer presence in accordance with one or more example embodiments. Referring to FIG. 7, at step 702, a computing platform may receive a plurality of messages comprising data indicating physical presence of customers of an organization at a physical location of the organization from an indoor positioning system located at the physical location of the organization. For example, computing platform 326 may receive, from indoor positioning system(s) 304, messages indicating physical presence of a customer presently in possession of personal computing device 312 at a location associated with indoor positioning system(s) 304 (e.g., Location “A”), a customer presently in possession of personal computing device 314 at a location associated with indoor positioning system(s) 304 (e.g., Location “A”), a customer presently in possession of personal computing device 318 at a location associated with indoor positioning system(s) 304 (e.g., Location “B”), and a customer presently in possession of personal computing device 320 at a location associated with indoor positioning system(s) 304 (e.g., Location “B”). Responsive to receiving the plurality of messages comprising the data indicating the physical presence of the customers of the organization at the physical location of the organization, at step 704, the computing platform may determine that at least one customer of the customers of the organization at the physical location of the organization is eligible for an additional assistance program offered by the organization. For example, computing platform 326 may determine that the customer presently in possession of personal computing device 314 is eligible for an additional assistance program offered by the organization and/or that the customer presently in possession of personal computing device 320 is eligible for an additional assistance program offered by the organization.

Responsive to determining that the at least one customer of the customers of the organization at the physical location of the organization is eligible for the additional assistance program offered by the organization, at step 706, the computing platform may generate a message identifying the at least one customer of the customers of the organization at the physical location of the organization, identifying the additional assistance program offered by the organization, and indicating that the at least one customer of the customers of the organization at the physical location of the organization is eligible for the additional assistance program offered by the organization, and, at step 708, may communicate the message identifying the at least one customer of the customers of the organization at the physical location of the organization, identifying the additional assistance program offered by the organization, and indicating that the at least one customer of the customers of the organization at the physical location of the organization is eligible for the additional assistance program offered by the organization to at least one computing device located at the physical location of the organization. For example, computing platform 326 may generate a message identifying the customer presently in possession of personal computing device 314, identifying the additional assistance program offered by the organization for which the customer presently in possession of personal computing device 314 is eligible, and indicating that the customer presently in possession of personal computing device 314 is eligible for the additional assistance program offered by the organization, and may communicate the message identifying the customer presently in possession of personal computing device 314, identifying the additional assistance program offered by the organization for which the customer presently in possession of personal computing device 314 is eligible, and indicating that the customer presently in possession of personal computing device 314 is eligible for the additional assistance program offered by the organization to personal computing device 314 and/or personal computing device 316.

Additionally or alternatively, computing platform 326 may generate a message identifying the customer presently in possession of personal computing device 320, identifying the additional assistance program offered by the organization for which the customer presently in possession of personal computing device 320 is eligible, and indicating that the customer presently in possession of personal computing device 320 is eligible for the additional assistance program offered by the organization, and may communicate the message identifying the customer presently in possession of personal computing device 320, identifying the additional assistance program offered by the organization for which the customer presently in possession of personal computing device 320 is eligible, and indicating that the customer presently in possession of personal computing device 320 is eligible for the additional assistance program offered by the organization to personal computing device 320 and/or personal computing device 322.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers and one or more networks. The functionality may be distributed in any manner, or may be located in a single computing device (e.g., a server, a client computer, and the like).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A method, comprising:
at a computing platform comprising at least one processor, a memory, and a communication interface:
receiving, via the communication interface and from an indoor positioning system located at a physical banking center location of a financial institution, a plurality of messages comprising data indicating physical presence of customers of the financial institution at the physical banking center location of the financial institution; and
responsive to receiving the plurality of messages comprising the data indicating the physical presence of the customers of the financial institution at the physical banking center location of the financial institution, determining, by the at least one processor, that at least one customer of the customers of the financial institution at the physical banking center location of the financial institution is eligible for an additional assistance program offered by the financial institution.

2. The method of claim 1, wherein the plurality of messages comprising data indicating the physical presence of the customers of the financial institution at the physical banking center location of the financial institution comprises a plurality of customer identifiers, each customer identifier of the plurality of customer identifiers identifying a customer of the customers of the financial institution at the physical banking center location of the financial institution.

3. The method of claim 2, comprising:
receiving, via the communication interface and from a customer management system of the financial institution, one or more messages comprising data indicating a plurality of customers of the financial institution that are eligible for one or more additional assistance programs offered by the financial institution;
generating, by the at least one processor, a plurality of records comprising the data indicating the plurality of customers of the financial institution that are eligible for the one or more additional assistance programs offered by the financial institution; and
storing, by the at least one processor and in the memory, the plurality of records comprising the data indicating the plurality of customers of the financial institution that are eligible for the one or more additional assistance programs offered by the financial institution.

4. The method of claim 3, wherein determining that the at least one customer of the customers of the financial institution at the physical banking center location of the financial institution is eligible for the additional assistance program offered by the financial institution comprises identifying, by the at least one processor and from amongst the plurality of records comprising the data indicating the plurality of customers of the financial institution that are eligible for the one or more additional assistance programs offered by the financial institution, at least one record comprising data associated with a customer identifier of the plurality of customer identifiers.

5. The method of claim 1, wherein the indoor positioning system comprises a plurality of personal computing devices presently in possession of the customers of the financial institution at the physical banking center location of the financial institution, and at least one location beacon that is located at the physical banking center location of the financial institution and configured to emit a signal comprising an identifier associated with the physical banking center location, and wherein receiving the plurality of messages comprising data indicating the physical presence of the customers of the financial institution at the physical banking center location of the financial institution comprises receiving, from the plurality of personal computing devices, data comprising the identifier associated with the physical banking center location.

6. The method of claim 5, wherein the indoor positioning system comprises a location beacon that is located at a first location of the physical banking center location of the financial institution and configured to emit a signal comprising an identifier associated with the first location of the physical banking center location of the financial institution, and a location beacon that is located at a second location of the physical banking center location of the financial institution and configured to emit a signal comprising an identifier associated with the second location of the physical banking center location of the financial institution, and wherein receiving the plurality of messages comprising data indicating physical presence of the customers of the financial institution at the physical banking center location of the financial institution comprises:
receiving messages comprising data indicating physical presence of a portion of the customers of the financial institution at the first location of the physical banking center location of the financial institution; and
receiving messages comprising data indicating physical presence of a portion of the customers of the financial institution at the second location of the physical banking center location of the financial institution.

7. The method of claim 6, wherein determining that at least one customer of the customers of the financial institution at the physical banking center location of the financial institution is eligible for the additional assistance program offered by the financial institution comprises:
determining, by the at least one processor, that a customer of the portion of the customers of the financial institution at the first location of the physical banking center location of the financial institution is eligible for the additional assistance program offered by the financial institution; and
determining, by the at least one processor, that a customer of the portion of the customers of the financial institution at the second location of the physical banking center location of the financial institution is eligible for the additional assistance program offered by the financial institution.

8. The method of claim 7, comprising:
receiving, via the communication interface and from the indoor positioning system located at the physical banking center location of the financial institution, messages comprising data indicating physical presence of associates of the financial institution at the first location of the physical banking center location of the financial institution; and
receiving, via the communication interface and from the indoor positioning system located at the physical banking center location of the financial institution, messages comprising data indicating physical presence of associates of the financial institution at the second location of the physical banking center location of the financial institution.

9. The method of claim 8, comprising:
identifying, by the at least one processor and from amongst the associates of the financial institution at the first location of the physical banking center location of the financial institution, an associate of the financial institution to assist the customer of the portion of the customers of the financial institution at the first location of the physical banking center location of the financial institution with the additional assistance program offered by the financial institution; and
identifying, by the at least one processor and from amongst the associates of the financial institution at the second location of the physical banking center location of the financial institution, an associate of the financial institution to assist the customer of the portion of the customers of the financial institution at the second location of the physical banking center location of the financial institution with the additional assistance program offered by the financial institution.

10. The method of claim 9, comprising:
generating, by the at least one processor, a message indicating that the customer of the portion of the customers of the financial institution at the first location of the physical banking center location of the financial institution is eligible for the additional assistance program offered by the financial institution; and
generating, by the at least one processor, a message indicating that the customer of the portion of the customers of the financial institution at the second location of the physical banking center location of the financial institution is eligible for the additional assistance program offered by the financial institution.

11. The method of claim 10, comprising:
identifying, by the at least one processor and based on the messages comprising data indicating physical presence of the portion of the customers of the financial institution at the first location of the physical banking center location of the financial institution, a personal computing device presently in possession of the customer of the portion of the customers of the financial institution at the first location of the physical banking center location of the financial institution;
identifying, by the at least one processor and based on the messages comprising data indicating physical presence of the portion of the customers of the financial institution at the second location of the physical banking center location of the financial institution, a personal computing device presently in possession of the customer of the portion of the customers of the financial institution at the second location of the physical banking center location of the financial institution;
communicating, via the communication interface and to the personal computing device presently in possession of the customer of the portion of the customers of the financial institution at the first location of the physical banking center location of the financial institution, the message indicating that the customer of the portion of the customers of the financial institution at the first location of the physical banking center location of the financial institution is eligible for the additional assistance program offered by the financial institution; and
communicating, via the communication interface and to the personal computing device presently in possession of the customer of the portion of the customers of the financial institution at the second location of the physical banking center location of the financial institution, the message indicating that the customer of the portion of the customers of the financial institution at the second location of the physical banking center location of the financial institution is eligible for the additional assistance program offered by the financial institution.

12. The method of claim 10, comprising:
identifying, by the at least one processor and based on the messages comprising data indicating physical presence of associates of the financial institution at the first location of the physical banking center location of the financial institution, a personal computing device presently in possession of the associate of the financial institution to assist the customer of the portion of the customers of the financial institution at the first location of the physical banking center location of the financial institution with the additional assistance program offered by the financial institution;
identifying, by the at least one processor and based on the messages comprising data indicating physical presence of associates of the financial institution at the second location of the physical banking center location of the financial institution, a personal computing device presently in possession of the associate of the financial institution to assist the customer of the portion of the customers of the financial institution at the second location of the physical banking center location of the financial institution with the additional assistance program offered by the financial institution;
communicating, via the communication interface and to the personal computing device presently in possession of the associate of the financial institution to assist the customer of the portion of the customers of the financial institution at the first location of the physical banking center location of the financial institution with the additional assistance program offered by the financial institution, the message indicating that the customer of the portion of the customers of the financial institution at the first location of the physical banking center location of the financial institution is eligible for the additional assistance program offered by the financial institution; and
communicating, via the communication interface and to the personal computing device presently in possession of the associate of the financial institution to assist the customer of the portion of the customers of the financial institution at the second location of the physical banking center location of the financial institution with the additional assistance program offered by the financial institution, the message indicating that the customer of the portion of the customers of the financial institution at the second location of the physical banking center location of the financial institution is eligible for the additional assistance program offered by the financial institution.

13. The method of claim 1, comprising:
responsive to determining that the at least one customer of the customers of the financial institution at the physical banking center location of the financial institution is eligible for the additional assistance program offered by the financial institution:
generating, by the at least one processor, a message identifying the at least one customer of the customers of the financial institution at the physical banking center location of the financial institution, identifying the additional assistance program offered by the financial institution, and indicating that the at least one customer of the customers of the financial institution at the physical banking center location of the financial institution is eligible for the additional assistance program offered by the financial institution; and
communicating, via the communication interface and to at least one computing device located at the physical banking center location of the financial institution, the message identifying the at least one customer of the customers of the financial institution at the physical banking center location of the financial institution, identifying the additional assistance program offered by the financial institution, and indicating that the at least one customer of the customers of the financial institution at the physical banking center location of the financial institution is eligible for the additional assistance program offered by the financial institution.

14. The method of claim 13, comprising identifying, by the at least one processor and based on the plurality of messages comprising data indicating physical presence of customers of the financial institution at the physical banking center location of the financial institution, the at least one computing device located at the physical banking center location of the financial institution, the at least one computing device located at the physical banking center location of the financial institution comprising a personal computing device presently in possession of the at least one customer of the customers of the financial institution at the physical banking center location of the financial institution.

15. The method of claim 13, comprising:
receiving, via the communication interface and from the indoor positioning system located at the physical banking center location of the financial institution, a plurality of messages comprising data indicating physical presence of associates of the financial institution at the physical banking center location of the financial institution; and
identifying, by the at least one processor and based on the plurality of messages comprising data indicating physical presence of associates of the financial institution at the physical banking center location of the financial institution, the at least one computing device located at the physical banking center location of the financial institution, the at least one computing device located at the physical banking center location of the financial institution comprising a personal computing device presently in possession of an associate of the associates of the financial institution at the physical banking center location of the financial institution.

16. The method of claim 1, wherein determining that the at least one customer of the customers of the financial institution at the physical banking center location of the financial institution is eligible for the additional assistance program offered by the financial institution comprises determining that the at least one customer of the customers of the financial institution at the physical banking center location of the financial institution is eligible for an additional assistance program offered by the financial institution that comprises a workout program for addressing one or more loans for which the at least one customer of the customers of the financial institution at the physical banking center location of the financial institution is currently eligible.

17. The method of claim 1, wherein determining that the at least one customer of the customers of the financial institution at the physical banking center location of the financial institution is eligible for the additional assistance program offered by the financial institution comprises determining that the at least one customer of the customers of the financial institution at the physical banking center location of the financial institution is eligible for an additional assistance program offered by the financial institution that comprises verifying one or more charges incurred by the at least one customer of the customers of the financial institution at the physical banking center location of the financial institution.

18. The method of claim 1, wherein determining that the at least one customer of the customers of the financial institution at the physical banking center location of the financial institution is eligible for the additional assistance program offered by the financial institution comprises determining that the at least one customer of the customers of the financial institution at the physical banking center location of the financial institution is eligible for an additional assistance program offered by the financial institution that comprises an incentive program for maintaining an account the at least one customer of the customers of the financial institution at the physical banking center location of the financial institution has with the financial institution that has a transaction history indicative of imminent closure.

19. An apparatus, comprising:
at least one processor;
a communication interface; and
a memory storing instructions that when executed by the at least one processor cause the apparatus to:
receive, via the communication interface and from an indoor positioning system located at a physical banking center location of a financial institution, a plurality of messages comprising data indicating physical presence of customers of the financial institution at the physical banking center location of the financial institution;
determine that at least one customer of the customers of the financial institution at the physical banking center location of the financial institution is eligible for an additional assistance program offered by the financial institution; and
responsive to determining that the at least one customer of the customers of the financial institution at the physical banking center location of the financial institution is eligible for the additional assistance program offered by the financial institution:
generate a message identifying the at least one customer of the customers of the financial institution at the physical banking center location of the financial institution, identifying the additional assistance program offered by the financial institution, and indicating that the at least one customer of the customers of the financial institution at the physical banking center location of the financial institution is eligible for the additional assistance program offered by the financial institution; and
communicate, via the communication interface and to at least one computing device located at the physical banking center location of the financial institution, the message identifying the at least one customer of the customers of the financial institution at the physical banking center location of the financial institution, identifying the additional assistance program offered by the financial institution, and indicating that the at least one customer of the customers of the financial institution at the physical banking center location of the financial institution is eligible for the additional assistance program offered by the financial institution.

20. One or more non-transitory computer-readable media having instructions stored thereon that when executed by one or more computers cause the one or more computers to:
receive, from an indoor positioning system located at a physical banking center location of a financial institution, a plurality of messages comprising data indicating physical presence of customers of the financial institution at the physical banking center location of the financial institution and associates of the financial institution at the physical banking center location of the financial institution;
identify, from amongst the customers of the financial institution at the physical banking center location of the financial institution, at least one customer that is eligible for an additional assistance program offered by the financial institution; and
identify, from amongst the associates of the financial institution at the physical banking center location of the financial institution, at least one associate to assist the at least one customer that is eligible for the additional assistance program offered by the financial institution.
